(19) United States
(12) Patent Application Publication
(10) Pub. No.: US 2026/0227172 A1
(43) Pub. Date: Aug. 6, 2026

(54) METHOD FOR DETERMINING A POSITION BY DIFFERENTIAL OPTICAL INTERFEROMETRY AND DIFFERENTIAL INTERFEROMETER FOR DOING THE SAME

(71) Applicant: PRODRIVE TECHNOLOGIES INNOVATION SERVICES B.V., Son en Breugel (NL)

(72) Inventors: Willem VAN DE SANDE, Son en Breugel (NL); Martijn ADRIAANS, Son en Breugel (NL); Sybren ZWETSLOOT, Son en Breugel (NL)

(21) Appl. No.: 19/149,482

(22) PCT Filed: Jan. 11, 2024
(86) PCT No.: PCT/NL2024/050012

§ 371 Date: Jul. 18, 2025

(30) Foreign Application Priority Data
Jan. 23, 2023 (NL) 2034004

(51) Int. Cl. G01B 9/02001; G01B 9/02015; G01B 9/02055

(52) U.S. Cl. CPC G01B 9/02007; G01B 9/02027; G01B 9/0207

(57) ABSTRACT

Determining a target reflector position in a measurement range by differential optical interferometry includes using a single frequency laser to generate a coherent source light beam modulated between first and second wavelengths. A light beam and delayed light beam are generated and each split into first and second parts arranged in parallel. First and second light signals are generated by guiding the first part of one beam along a first path including the target reflector and the second part along a second path including a reference reflector. Third and fourth light signals are generated by guiding the first and second parts of the other beam along third and fourth paths. First and second interference signals are generated between the first and third light signals and the second and fourth light signals, respectively. A position of the target reflector is based on the first and second interference signals.

### TECHNICAL FIELD

The present disclosure relates to a method for determining a position of a target by differential optical interferometry with high stability and high precision and a differential optical interferometer for doing the same.

### BACKGROUND

Differential optical interferometers may be used for measuring a difference in an optical path length towards a movable target with respect to an optical path length towards a reference by generating an interference signal from an interaction between light that has travelled the reference optical path and light that has travelled a target optical path. A generic concern with differential interferometry and differential interferometers are changes in optical path length caused by environmental factors such as temperature changes, because this may affect the length of the beam's path and the refractive indices of the medium through which the beam passes which both influence and determine the optical path length. Other generic concerns are providing adequate spatial resolution, preferably uniform spatial resolution, determining a phase and a direction of travel.

U.S. Pat. No. 8,570,529 B2 describes a position detection device comprising a differential interferometer to produce an interference pattern dependent on the length of the measurement section and a detector, which takes the detected interference pattern as a basis for producing a measurement signal. The position detection device further comprises a source, for producing a wave field in the measurement section, a wave field variation device for varying the wavelength of the wave field over time, and an evaluation circuit for evaluating the measurement signal on the basis of the variation over time. A disadvantage of this solution is that it may require a relatively large dynamic range on the modulation input which introduces noise in the measurements. A further disadvantage of this solution is that it is complex to implement in a system wherein the position is detected along multiple axes, particularly when a same modulation depth is desired along multiple axes. Furthermore, it does not allow to determine an accurate position in situations where the reference distance and the target distance may be equal, which may typically occur in free-space solutions.

CN 112432602 A, US 2021/0199418 A1 and CN 112857206A each describe differential interferometers comprising complex and costly optics for modulating a phase of a reference signal to measure a target distance with a stable modulation depth.

### SUMMARY

It is an object of the present disclosure to solve at least one, preferably all of the disadvantages related to the prior art.

According to a first aspect of the present disclosure the object is achieved by providing a method for determining a position by differential optical interferometry of a target reflector in a measurement range (e.g. along an axis) according to the appended claims. A coherent source light beam may be generated using a single frequency laser, wherein the coherent source light beam is modulated between a first and a second wavelength. A light beam and a delayed light beam may be generated from the coherent source light beam, wherein the delayed light beam comprises a delay with respect to the light beam. The light beam is preferably arranged in parallel to (and spatially separated from) the delayed light beam. Each of the light beam and the delayed light beam is split into a first and second part, wherein the second part is arranged in parallel to (and spatially separated from) the corresponding first part. A first light signal may be generated by guiding the first part of one of the light beam and delayed light beam along a first path comprising the target reflector. A second light signal may be generated by guiding the second part of the one of the light beam and delayed light beam along a second path comprising a reference reflector, wherein the second path is arranged in parallel to (and spatially separated from) the first path. A third light signal may be generated by guiding the first part of the other one of the light beam and delayed light beam along a third path. A fourth light signal may be generated by guiding the second part of the other one of the light beam and delayed light beam along a fourth path, and wherein the fourth path is arranged in parallel to (and spatially separated from) the third path. A first interference signal may be generated between the first light signal and the third light signal. A second interference signal may be generated between the second light signal and the fourth light signal. A position of the target reflector may be determined based on the first and the second interference signal.

The method achieves the object of the present disclosure by generating two interference patterns, a first one for the first light signal (e.g. a target signal) and a second one for the second light signal (e.g. a first reference signal), wherein such light signals interfere with another reference signal (e.g. the third and the fourth, respectively) having an optical path length difference being introduced by a delay between generating the light beam and the delayed light beam. This reduces a relative variation in (phase) modulation depth, even for a constant frequency modulation of the coherent source light beam, and therefore avoids adjusting the modulation depth depending on the target position. This enables and/or simplifies reducing the noise in measurements. Furthermore, it is advantageous to minimize the variation in modulation depth especially where position measurements are performed along multiple axes, since this improves the contrast of the interference between the different signals.

Furthermore, by guiding respective parts of the light beam and the delayed light beam along the indicated optical paths, comprising parts that are arranged in parallel and spatially separated, reduces the sensitivity to environmental influences (e.g. temperature, magnetic fields, shear stress) that may affect the optical path lengths of such paths, because such environmental influences affect both interference patterns to the same extent. Therefore, any of these environmental influences will be compensated, when determining a position of the target reflector based on the first and the second interference signal.

By modulating the wavelength of the coherent source light beam between two states, for instance by modulating between a first (single) wavelength generated at a first instance of time and a second (single) wavelength generated at a second instance of time, the sign information of the phase difference may be resolved. It may also improve the resolution of the pathlength difference, by levelling the resolution throughout the range of pathlength differences over a measurement range of the target along the axis. Preferably, the wavelength is modulated according to a sine wave. This may simplify the generation and/or processing of signals. However, any other transition of the laser wavelength will also be possible. The frequency of the coherent source light beam may be modulated by modulating a light source, such as a (single frequency) laser, of a light generating means using a modulator, wherein the light generating means may comprise the modulator. The modulation frequency, being the frequency of modulating the coherent source light beam between the first wavelength and the second single wavelength, may be chosen/adapted based on the maximum speed of the target reflector.

Beneficially, the first, second, third and fourth light signal are generated using a sensor head being configured to provide single pass interferometry. The benefit of such a sensor head is that it can minimize non-linearity errors due to misalignment of optical components provided by the sensor head.

Preferably, the light generating means comprises a low cost light source. The light source is beneficially configured for emitting light having a single wavelength at a time. Advantageously, the light source is capable of being modulated to change the single wavelength between two or more states, wherein each state corresponds to a different single wavelength. The light source may be configured for changing between the two or more states by means of adapting a parameter of the light source, such as a (driving) current, a (driving) voltage or a temperature. Beneficially, the light source is configured for having a linear correlation between an adaptation of the parameter and a change of the single wavelength. The light source may for instance comprise a tuneable homodyne light source (e.g. a single frequency laser), such as a semiconductor or diode laser, which typically offer a low cost light source. Examples of an advantageous light source are a distributed feedback (DFB) laser and a Distributed Bragg Reflector (DBR) laser. Alternatively, a vertical-cavity surface-emitting laser (VCSEL) may for example be used as an advantageous light source for embodiments configured for a limited target distance.

For determining the position of the target reflector, a first and a second set of quadrature signals may be determined by demodulating the first and second interference signal, respectively, according to a demodulation scheme. Several modulation schemes will be suitable, as will be apparent to a person skilled in the art. For instance, the first and second interference signal may be demodulated at a first frequency corresponding to the modulation frequency and at a second frequency corresponding to twice the modulation frequency. Another example is to filter the first and second interference signal using a low pass filter and to demodulate the first and second interference signal at the modulation frequency.

The measurement range preferably comprises all potential positions of the target reflector over the target reflector overall excursion along an axis. The position of the target reflector may be determined within the measurement range, for instance to monitor the position of a stage attached to the target reflector.

The target reflector may comprise any type of suitable reflector, such as a cube corner, a retroreflector or a plane mirror. Preferably, the target reflector comprises a plane mirror to enlarge the tolerances on translation of the target reflector in a direction orthogonal to the incident light. For metrology of stage position this advantage is critical because a translation in a direction orthogonal to the measurement direction does not affect the interference signals. Therefore, determining the position of the target reflector along the measurement range is not affected. The main benefit is that this allows monitoring the position of the target or the stage along orthogonal measurement ranges, because it provides decoupled position measurements along orthogonal axes.

The reference reflector may comprise any type of suitable reflector, such as a retroreflector (e.g. cube corner) or a plane mirror. Preferably, the target reflector comprises a plane mirror because a plane mirror can translate with respect to the interferometer in a direction orthogonal to the measurement direction without affecting the measurement, creating the possibility for a decoupled displacement measurements along orthogonally arranged axes.

A fifth, sixth, seventh and eighth path is defined by the (entire) optical path that light generated by the light source travels to form the first, second, third and fourth light signal, respectively. Advantageously, the fifth and sixth path or the seventh and eighth path comprise the delay. This ensures that the first and second interference signal are each generated from respective signals being unbalanced (i.e. unbalanced first and third light signal, and unbalanced second and fourth light signal), wherein a first ratio, between an optical path length of the fifth path and an optical path length of the seventh path, and a second ratio, between an optical path length of a sixth path and an optical path length of an eighth path, are each one of greater than 1 and smaller than 1. Such delay reduces a relative variation in (phase) modulation depth, even for a constant frequency modulation of the source, and therefore avoids adjusting the modulation depth depending on the target position. This enables and/or simplifies reducing the noise in measurements, because by reducing the relative variation in the measured distances, the required variation in modulation input may be reduced. Furthermore, it is advantageous to minimize the variation in modulation depth especially in case measurements are performed for multiple (orthogonal) axes, since this may improve the contrast of the interference between the different signals and therefore may improve the signal strength of the demodulated signals for a measurement range of target distances for such axes.

The light beam and the delayed light beam may be generated from a (single) coherent source light beam. This coherent light beam is preferably generated by a (single) light source to assure that changes influencing the light source (e.g. switching of frequencies between states) affect both light beams simultaneously without requiring any additional means for instance for synchronization. Advantageously, the delayed light beam is generated using a first light guide, when it departs a first optical terminal of the first light guide. Optionally, the light beam is generated using a second light guide, when it departs a second optical terminal of the second light guide.

The light beam and the delayed light beam are preferably arranged in parallel (and spatially separated), such that external influences on the optical path downstream of the respective optical terminal equally affect the optical path length travelled by both the light beam and the delayed light beam. To that end, the first and second optical terminal are advantageously aligned in parallel.

Generating the delayed light beam and the light beam preferably comprises splitting the coherent source light beam into a first and second portion, respectively, that are spatially separated. The coherent source light beam may for instance be split using a beam splitter (e.g. fiber-based beam splitter, free-space beam splitter). Subsequently, the first portion may be guided along a delay path (e.g. the first light guide) and the second portion may be guided along a path (e.g. the second light guide). Preferably, an optical path length of the delay path is larger than an optical path length of the path.

Preferably, the delay is provided by an optical path length difference between the delay path and the path. The benefit of providing the delay in such manner is that environmental influences such as thermal expansion equally affects the optical path length of the fifth and sixth path or the seventh and eighth path, resulting in a similar effect on a first delay between the first and third light signal and between the second and fourth light signal. Therefore, determining the position of the target is essentially unaffected by these environmental influences. Advantageously, one of both the fifth and sixth path and both the seventh and eighth path comprise the delay path and the other one of both the fifth and sixth path and both the seventh and eighth path comprise the path. Preferably, both the fifth and sixth path comprise the delay path, because both these paths typically require a larger optical path length than the other paths, to account for the measurement range of the target. Therefore, a length of such delay path can typically be smaller than a length of a delay path provided in the seventh and eighth path.

Advantageously, the delay corresponds to an optical path length (e.g. an optical path length difference between the delay path and the path) which is longer than the measurement range of the target reflector to minimize the relative variation in path length difference for decoupled position measurements along different (orthogonal) axes. Furthermore, since the modulation depth is proportional to the optical path length difference between the interfered light signals, the variation in modulation depth between independent differential optical interferometers can also be minimized.

The delay may be configured to correspond to an optical path length difference configured such that an amplitude of each of the demodulated first and second interference signal does not exhibit a zero crossing due to a change of a phase modulation depth of any of the first and second interference signals over a measurement range of the target reflector of the interferometer for a (constant) frequency modulation amplitude of the light generating means (e.g. the light source). This may be achieved when the delay is longer than the measurement range, for instance when the delay corresponds to an optical path length being at least twice as long as the measurement range of the target. For instance, the delay is chosen such that a third ratio between the measurement range of the target reflector and an absolute value of a difference between the optical path length of the sixth path and the optical path length of the eighth path is greater than 2, preferably greater than 2.1, preferably greater than 2.2. This can typically be achieved when both the first and second ratio are one of substantially greater than 10 and substantially smaller than 0.1. In the event that the fifth and sixth path comprise the delay, such that light provided by the delay is used for generating light of the first and second light signal, the optical path length of the delay may substantially be an order of magnitude longer than the optical path length of the seventh or eighth path. Preferably, the optical path length of the delay is chosen such that an amplitude of each quadrature signal of the first and the second set of quadrature signals does not exhibit a zero crossing over a measurement range of the target reflector. Preferably, the optical path length of the delay is chosen such that an amplitude of each quadrature signal of the first and the second set of quadrature signals are sufficiently great over the measurement range of the target reflector such that a signal to noise ratio can be achieved that does not limit the sensor performance. For instance, the optical path length of the delay is chosen such that an amplitude of each quadrature signal of the first and the second set of quadrature signals does not vary by more than a factor four. Preferably, the optical path length of the delay is chosen such that an amplitude of each quadrature signal of the first and the second set of quadrature signals does not vary by more than a factor two.

Preferably, the light generating means comprises a light guide configured as a delay path. A delay path comprising a light guide has the benefit that it can be used to introduce a large and identical path length difference between the first and third light signal and between the second and fourth light signal in a relatively small space. For instance, if such light guide is longer than the measurement range, the relative variation in path length difference for independent measurements axes is minimized. Furthermore, since the modulation depth is proportional to the path length difference between the interfered beams the variation in modulation depth between independent differential optical interferometers can also be minimized.

The delay path may comprise a first light guide for offering a simple and compact means for delaying light. The first light guide may form a first optical terminal being configured to generate the delayed light beam. Additionally or alternatively, the path comprises a second light guide. The second light guide may comprise a second optical terminal configured to generate the light beam.

Preferably, light is collimated along at least part of the fifth, sixth, seventh and eighth path. This is particularly beneficial for the at least part of the respective optical paths being free-space.

A first beam splitter, such as a non-polarizing beam splitter (e.g. a lateral displacement beam splitter, a modified cube beam splitter), may be provided for splitting each of the light beam and the delayed light beam into a first and second part that are spatially separated from one another. The first beam splitter may be provided downstream of the light generating means, for instance downstream of the first and second optical terminal. The first beam splitter may introduce a second delay between the first and corresponding second part. Preferably, the second delay introduced between the first and second part of the light beam corresponds to the second delay introduced between the first and second part of the delayed light beam. Such corresponding delays equally influences the first and second interference pattern and therefore does not affect determining the position.

A second beam splitter may be provided for generating the first, second, third and fourth light signal. The second beam splitter may be provided downstream of the first beam splitter. For instance, the first, second, third and fourth path may comprise the second beam splitter, such as non-polarizing or a polarizing beam splitter. The first and second path may traverse the second beam splitter twice. A first time, by light traveling towards the corresponding reflector. A second time, by light reflected by the corresponding reflector and traveling towards the detecting means (e.g. a corresponding detector of the detecting means).

In a preferred embodiment, an optical path length of the fourth path corresponds to an optical path length of the third path such that environmental influences, for instance causing thermal expansion, equally affect the third and fourth light signal.

A quarter wave plate (QWP) may be provided in the first and/or second path, for instance between the second beam splitter and the target reflector and/or between the second beam splitter and the reference reflector. This is specifically beneficial for embodiments wherein the second beam splitter comprises a polarizing beam splitter to reduce noise in the respective signals.

Polarizing means may be provided to generating the first and second interference signal. This is specifically beneficial for embodiments wherein the second beam splitter comprises a polarizing beam splitter. The polarizing means may comprise a single (linear) polarizer to generating the first and second interference signal. Alternatively, the polarizing means comprises a first and second polarizer to generating the first and second interference signal, respectively. The first and second polarizer may be oriented to optimize the respective interference signal, for instance by improving the contrast. For instance, the polarizer means may be configured to have an adjustable orientation of each polarizer to change a direction of polarization such that the intensity ratio between the respective interfered signals can be adjusted to optimize (maximize) interference contrast.

The detecting means may comprise a first and a second detector to detect the first and the second interference signal, respectively, such that a position of the target reflector can be determined. To this end a processing means (e.g. a processing unit) may be provided, wherein the detecting means (e.g. the first and second detector) are connected to the processing means. The processing means may be configured to determine the position of the target reflector by calculating a difference between the first path and the second path, wherein the difference may be based on the first and second interference signal for the coherent source light beam being modulated between the first and second wavelength.

To determine the position of the target reflector, a quadrature may be determined, for instance by the processing means, by demodulating each of the first and second interference signal according to a demodulation scheme. Several modulation schemes will be suitable, as will be apparent to a person skilled in the art. For instance, the first and second interference signal may be demodulated at a first frequency corresponding to a modulation frequency and at a second frequency corresponding to twice the modulation frequency. Another example is to filter the first and second interference signal using a low pass filter and to demodulate the first and second interference signal at a modulation frequency. The modulation frequency being the frequency wherein the light generating means is modulated or switched between the first and second state.

In a preferred embodiment, the method further comprises a calibration step to determine the position of the target more accurately. The calibration step for instance comprises determining a first amplitude of the first interference signal and a second amplitude of the second interference signal. A first signal (e.g. electrical signal) may be generated based on the first interference signal and the first amplitude. A second signal (e.g. electrical signal) may be generated based on the second interference signal and the second amplitude. For instance, the determined first and second amplitude may be used to adapt a sensitivity of the detecting means being used to generate a first and a second signal for the first and second interference signal, respectively. For instance, the first amplitude may be used to adapt a sensitivity of a first detector of the detecting means and the second amplitude may be used to adapt a sensitivity of a second detector of the detecting means. Preferably, each sensitivity is adapted such that the measurement range(s) of the detecting means are optimally (e.g. fully) used. For instance, the detecting means comprises at least one analogue to digital converter (ADC) and the calibration step is used to adapt a sensitivity of an ADC such that a range of corresponding interference signal corresponds to measurement range of the ADC.

The first and second amplitude may be determined by peak detection or by regular sampling of the interference signal. Preferably, the first and second amplitude is determined based on a set of zero crossings for the first and the second interference signal, respectively, wherein the set of zero crossing preferably comprises at least three consecutive zero crossings. The benefit of zero crossing detection is that the accuracy of determining the amplitude is often higher than for sampling data for peak detection. For instance, the first and second amplitude may be determined based on a minimum value of the respective interference pattern (e.g. reached halfway between a first and second zero crossing of the set of zero crossings) and a maximum value of the respective interference pattern (e.g. reached halfway between the second and third zero crossing of the set of zero crossings). For faster moving targets, it may be beneficial to determine the first and second amplitude based on fitting a (periodic) function, for instance a trigonometric function such as a cosine function, to the respective interference signal. For instance, the first and second amplitude may be determined based on fitting a first and a second function on the first and second interference signal, respectively.

However, in some situations such zero crossing may not occur automatically. For example, zero crossings may not occur when the optical path length of the first path is substantially constant (e.g. changes by less than 1/16th or ⅛th of the wavelength), for instance zero may not occur when the target reflector is stationary along the measurement range. Without zero crossings it is impossible to discriminate between disturbances that influence the interference pattern and changes of the optical path length of the first path (e.g caused by movement of the target reflector along the measurement range). Such disturbances may comprise factors affecting the guidance of light in one of the respective optical paths, such as a part of the fifth path (e.g. the first path), to some extent, for instance caused by one of particulate matter, condensation or fouling of optical components, changes in alignment of optical components. Additionally or alternatively, such disturbances may comprise factors affecting signal detection and processing, for instance caused by thermal drift of electronics such as the electronics of the detecting means. In any of such situations, zero crossings in an interference signal may be forced by adapting (e.g. modulating) an optical path length of one of the optical paths, such as the fifth path, corresponding to the interference signal. For instance, an optical path length of the first optical path may be adapted by moving the target reflector. Preferably, the optical path length is modulated such that it oscillates with an amplitude of at least half of one of the first wavelength, the second wavelength and a nominal value of the first and second wavelength, preferably an amplitude of at least half of the larger one of the first and second wavelength. Beneficially, the delay is adapted (e.g. modulated) such that the optical path length difference varies by at least an optical path length corresponding to one of the first wavelength, the second wavelength and a nominal value of the first and second wavelength, preferably to the larger one of the first and second wavelength. In a preferred embodiment, the optical path length difference introduced by the delay is adapted. The advantage of adapting an optical path length of the delay is that both interference patterns are affected to the same extent. Therefore, the adaptation of the optical path length is automatically cancelled out when determining the position of the target reflector. Preferably, the optical path length difference introduced by the delay is modulated with an amplitude corresponding to at least half of one of the first wavelength, the second wavelength and a nominal value of the first and second wavelength, preferably an amplitude of at least half of the larger one of the first and second wavelength.

The delay may be adapted by adapting the optical path length of one of the path and the delay path. Preferably, the delay is adapted by adapting the optical path length of the delay path, because an appropriate change of optical path length is more easily achieved in the path having a longest optical path length.

The optical path length of (part of) a path (e.g. the delay path) may be adapted or modulated by changing at least one of a refractive index in (the part of) the path and a length of (part of) the path. In a beneficial embodiment the optical path length difference between the path and the delay path is configured to oscillate with an amplitude of at least half of one of the first wavelength, the second wavelength and a nominal value of the first and second wavelength, preferably an amplitude of at least half of the larger one of the first and second wavelength. For instance, exposing one of the paths (e.g. delay path) to a magnetic field (e.g. generated by an electromagnetic coil) when such path for instance comprises a pockels cell, exposing one of the paths (e.g. delay path) to heat (e.g. generated by a heating element) or exposing one of the paths (e.g. delay path) to a shearing force (e.g. generated by an actuator) may change the optical path length. In a preferred embodiment heat is applied to the delay path. For instance, at least part of the delay path (e.g. light guide) is exposed to a heating element configured to (alternatingly) heat the first light guide. In a beneficial embodiment, at least part of the first light guide is wound around the heating element.

The optical path length may be oscillated at an oscillation frequency, which is preferably at least 1 Hz and more preferably at least 10 Hz. A temperature setpoint for heating the light guide may be chosen such that cooling speeds correspond to the chosen oscillation frequency. For instance, by increasing the difference between a nominal temperature of the light guide and an environmental temperature of the light guide, the oscillation frequency may be increased. The environment of the light guide may also be actively cooled to lower the environmental temperature of the light guide and thereby increase an upper limit of the oscillation frequency.

According to a second aspect of the present disclosure the object is achieved by a differential optical interferometer according to the appended claims. The differential optical interferometer reaches the object of the present disclosure in a similar way as the method according to the first aspect, wherein related features equally apply mutatis mutandis to the differential optical interferometer, or vice versa to the method according to the first aspect.

The differential optical interferometer for determining a position of a target reflector in a measurement range may comprise a light generating means. The light generating means may comprise a single frequency laser and may be configured to generate a coherent source light beam being modulated between a first and a second wavelength. The light generating means may further comprise a first and a second optical terminal. The light generating means may be configured to manipulate the coherent source light beam to generate a delayed light beam at the first terminal and a light beam at the second terminal, wherein the delayed light beam is delayed with respect to the light beam. The differential optical interferometer may further comprise a sensor head provided downstream of the first and second optical terminal. The delayed light beam may be arranged in parallel to the light beam. The sensor head may comprise a first beam splitter and a second beam splitter provided downstream of the first beam splitter. The first beam splitter may be configured to split each of the light beam and the delayed light beam into a first and second part. The second beam splitter may be configured to generate a first light signal by guiding the first part of one of the light beam and delayed light beam along a first path comprising a target reflector. The second beam splitter may further be configured to generate a second light signal by guiding second part of the one of the light beam and delayed light beam along a second path comprising a reference reflector. The second path may be arranged in parallel to the first path. The second beam splitter may further be configured to generate a third light signal by allowing passage of at least part of the first part of the other one of the light beam and delayed light beam along a third path. The second beam splitter may further be configured to generate a fourth light signal by allowing passage of at least part of the second part of the other one of the light beam and delayed light beam along a fourth path. The fourth path may be arranged in parallel to the third path. The sensor head may further be configured to generate a first interference signal between the first light signal and the third light signal, and to generate a second interference signal between the second light signal and the fourth light signal. The sensor head may further comprise a detecting means configured to detect the first and the second interference signal, respectively. The differential optical interferometer may further comprise a processing means configured for determining a position of the target reflector based on the first and second interference signal.

The differential optical interferometer may comprise a light generating means comprising a light source, as described for the first aspect. The light source for instance comprises a tuneable homodyne laser, which generally is a low-cost light source. The light source may be configured for being modulated between a first state and a second state. The light source for instance comprises a laser configured for being modulated between the first state and the second state. In the first state (e.g. at a first instance of time), the light generating means may be configured for generating monochromatic light at a first wavelength. In the second state (e.g. at a second instance of time), the light generating means may be configured for generating monochromatic light at a second wavelength different from the first wavelength. Preferably, light source generates a coherent source light beam (e.g. a coherent collimated source light beam), which may downstream be used to generate the light beam and the delayed light beam for instance by splitting the coherent source light beam using a first beam splitter, as described for the first aspect.

The light generating means may further comprise a modulator, configured to modulate a wavelength of the coherent source light beam. Modulation of the wavelength between two states may be achieved by modulating the light source. For instance, the light generating means comprises a modulator, as described for the first aspect. The modulator may be configured to modulate the coherent source light beam, such that light at the first wavelength is emitted by the light generating means in the first state and such that light at the second single wavelength is emitted by the light generating means in the second state. Such modulator may for instance be configured to adapt a parameter of the light source such as such as a (driving) current, a (driving) voltage or a temperature.

The light generating means is configured to manipulate the coherent source light beam to generate the delayed light beam at the first terminal and generate the light beam at the second terminal. To that end, the light generating means may be configured to split the coherent source light beam into a first portion and a second portion which may be used generate the delayed light beam and the light beam, respectively. To split the coherent source light beam, the light generating means may comprise a beam splitter, as described for the first aspect. To generate the delayed light beam and the light beam, the light generating means may comprise light guiding means configured to provide a delay path and a path, respectively. Preferably, the delay is generated by a delay path having an optical path length being longer than an optical path length of the path. In a beneficial embodiment, the light generating means comprises a first light guide (provided downstream of the beam splitter), as described for the first aspect. A (downstream) end of the first light guide may be configured to form the first optical terminal of the light generating means. Additionally or alternatively, the light generating means may comprise a second light guide (provided downstream of the beam splitter), as described for the first aspect. A (downstream) end of the second light guide may be configured to form the first optical terminal of the light generating means. The benefit of using light guides instead of folding optics, is that light guides can provide a relatively long optical path in a compact manner, while typically being more robust. In a preferred embodiment, the beam splitter and at least part of the first and second light guide are provided by a single fiber-based beam splitter.

The sensor head may comprise a first beam splitter as described for the first aspect, for splitting each of the light beam and the delayed light beam into a first and second part. The sensor head may comprise a second beam splitter as described for the first aspect, to generating the first, second, third and fourth light signal. The second beam splitter may be provided downstream of the first beam splitter. The sensor head may further comprise a quarter wave plate as described for the first aspect, to generate the first and second light signal. The sensor head may further comprise a polarizing means as described for the first aspect, to generate the first and second interference signal. The sensor head may further comprise a detecting means as described for the first aspect to detect the first and the second interference signal.

Differential optical interferometer may further comprise processing means as described for the first aspect for determining a position of the target reflector based on the first and second interference signal. The processing means may be configured for demodulating each of the first and second interference signal according to a demodulation scheme.

In a beneficial embodiment, the differential optical interferometer may be configured to determine a first and second amplitude of the first and second interference signal, respectively, such that the detection of the first and second interference signal can be controlled. For instance, the sensor head (e.g. the detecting means) or the processing means may be configured to determine the first and second amplitude and be configured to control the detection of the first and second interference signal. Such amplitudes may for instance be determined with a relatively high accuracy in the event it is based on detecting zero crossings of the first and second interference signal. For faster moving targets, it may be beneficial to determine the first and second amplitude based on fitting a (periodic) function, for instance a trigonometric function such as a cosine function, to the respective interference signal. For instance, the first and second amplitude may be determined based on fitting a first and a second function on the first and second interference signal, respectively.

The differential optical interferometer may further comprise an adapting means configured to adapt the optical path length difference such that zero crossings occur in the first and second interference signal. Preferably, the adapting means are configured to adapt or modulate the optical path length difference by at least an optical path length corresponding to one of the first wavelength, the second wavelength and a nominal value of the first and second wavelength, preferably by at least an optical path length corresponding to the larger one of the first and second wavelength. Alternatively, the adapting means are configured to adapt modulate the delay such that the optical path length difference oscillates with an amplitude of at least half of one of the first wavelength, the second wavelength and a nominal value of the first and second wavelength, preferably an amplitude of at least half of the larger one of the first and second wavelength. Beneficially, the adapting means are configured to adapt the common delay with an oscillation frequency preferably of at least 1 Hz, more preferably of at least 10 Hz.

The optical path length difference may be adapted by changing at least one of a refractive index and a length of the path or the delay path. The adapting means may therefore be configured to expose such path to at least one of heat, a shearing force or a magnetic field. Examples of such adapting means comprise a heating element, an actuator and an electromagnetic coil. For instance, the delay path (e.g. the first light guide) may at least in part be exposed to (e.g. wound around) a heating element.

Differential optical interferometers according to the present disclosure are particularly beneficial in situations wherein multiple measurements need to be compared, such as in situations where distances are determined along multiple axes. Such a system, for instance comprises a plurality of differential optical interferometers as described herein. Preferably, individual ones of the plurality of differential optical interferometers are configured for measuring a distance along a plurality of axes. Advantageously, such a system comprises a common light source for generating a source light beam, wherein the common light source is configured upstream of the plurality of differential optical interferometers. The benefit of such a system, for instance comprising a (single) laser source (e. g modulated line locked laser source) as the common light source, is suitable for performing a number of independent position measurements each with approximately the same (optimized) modulation depth.

As will be evident to the person skilled in the art, various segments along the different optical paths may be configured in a free-space or fiber-based solution. Preferably, fibers used in a fiber-based solution are configured for maintaining a polarization state, such polarizing maintaining fibers make interference signals less sensitive to fiber deformation.

According to a third aspect of the present disclosure the object is achieved by providing a method according to the clauses recited in this paragraph. The method reaches the object of the present disclosure in a similar way as the method and interferometer according to the first aspect and second aspect, respectively, wherein related features may equally apply mutatis mutandis to the method according to the third aspect as will be evident to a person skilled in the art.

Clause 1: Method for determining a position of a target reflector in a measurement range by optical interferometry comprising the steps of:
Generating a coherent source light beam using a single frequency laser, wherein the coherent source light beam is modulated between a first and a second wavelength,
Generating a delayed light beam and a light beam from the coherent source light beam, wherein the light beam is arranged in parallel to the delayed light beam,
Splitting each of the light beam and the delayed light beam into a first and second part, wherein the second part is arranged in parallel to the corresponding first part,
Generating a first light signal by guiding the first part of one of the light beam and delayed light beam along a first path comprising the target reflector,
Generating a second light signal by guiding the second part of the one of the light beam and delayed light beam along a second path,
Generating a third light signal by guiding the first part of the other one of the light beam and delayed light beam along a third path comprising the target reflector,
Generating a fourth light signal by guiding the second part of the other one of the light beam and delayed light beam along a fourth path,
   Wherein a first part of the second path and a first part of the fourth path overlap, a second part of the second path and a part of the third path overlap, and a second part of the fourth path and a part of the first path overlap,
Generating a first interference signal between the first light signal and the third light signal,
Generating a second interference signal between the second light signal and the fourth light signal,
Determining a position of the target based on the first and the second interference signal, preferably wherein the position is determined by determining a quadrature by demodulating each of the first and second interference signal, and wherein the optical path length of the delay path is configured such that an amplitude of each demodulated first and the second interference signal does not exhibit a zero crossing over a measurement range of the target reflector, preferably such that an amplitude of each demodulated first and the second interference signals does not vary by more than a factor four, preferably a factor two.

Clause 2: Method according to clause 1, wherein the step of generating the delayed light beam and the light beam from the coherent source light beam, comprises splitting the coherent source light beam into a first portion and a second portion, respectively, and guiding the first portion along a delay path to generate the delayed light beam, and guiding the second portion along a path to generate the light beam, wherein an optical path length of the delay path is larger than an optical path length of the path.

Clause 3: Method according to clause 1 or 2, comprising the steps of determining a first amplitude of the first interference signal and a second amplitude of the second interference, and wherein the step of determining the position of the target reflector is further based on the first and second amplitude.

Clause 4: Method according to clause 3, wherein the first and second amplitude are determined by one of detecting zero crossings of the first and second interference signal and fitting a first and second function to the first and second interference signal, respectively.

Clause 5: Method according to clause 3 or 4, wherein the delay corresponds to an optical path length difference and wherein the optical path length difference is modulated with an amplitude corresponding to at least half of one of the first wavelength, the second wavelength and a nominal value of the first and second wavelength, preferably an amplitude of at least half of the larger one of the first and second wavelength.

Clause 6: Method according to clause 5, wherein the optical path length difference is modulated by changing at least one of a length and a refractive index, preferably by exposure to at least one of heat, shear stress and a magnetic field.

According to a fourth aspect of the present disclosure the object is achieved by providing a differential optical interferometer according to the clauses recited in this paragraph. The differential optical interferometer reaches the object of the present disclosure in a similar way as the method and interferometer according to the first aspect and second aspect, respectively, wherein related features may equally apply mutatis mutandis to the differential optical interferometer according to the fourth aspect as will be evident to a person skilled in the art.

Clause 7: Differential optical interferometer for determining a position of a target reflector in a measurement range comprising,
A light generating means comprising a single frequency laser and being configured to generate a coherent source light beam modulated between a first and a second wavelength,
The light generating means further comprising a first and a second optical terminal, wherein the light generating means is configured to manipulate the coherent source light beam to generate a delayed light beam at the first optical terminal and a light beam at the second optical terminal, wherein the delayed light beam is delayed with respect to the light beam,
A sensor head provided downstream of the first and second optical terminal, wherein the delayed light beam is arranged in parallel to the light beam, wherein
   the sensor head comprises a first beam splitter, a second beam splitter, a first detector and a second detector, wherein
      the first beam splitter is configured to split the delayed light beam into a first and second part, and to guide the first part of the delayed light beam towards the first detector along a first path comprising the target reflector to form the first light signal, and to guide the second part of the delayed light beam towards the second detector along a second path traversing the second beam splitter to form the second light signal, wherein
      the second beam splitter is configured to split the light beam into a first and second part, and to guide the first part of the light beam towards the second detector along a third path comprising the target reflector to form the third light signal, and to guide the second part of the light beam towards the first detector along a second path traversing the first beam splitter to form the fourth light signal, wherein
   the sensor head is further configured to generate a first interference signal between the first light signal and the third light signal, and to generate a second interference signal between the second light signal and the fourth light signal, and wherein
   the sensor head comprises a first and a second detector configured to detect the first and the second interference signal, respectively, and
   a processing means configured for determining a position of the target reflector based on the first and second interference signal, preferably wherein the processing means is configured to determine the position by determining a first and a second set of quadrature signals by demodulating the first and second interference signal, respectively, and wherein the delayed light beam is delayed with respect to the light beam by introducing an optical path length difference configured such that an amplitude of each quadrature signal of the first and the second set of quadrature signals does not exhibit a zero crossing over the measurement range, preferably such that an amplitude of each quadrature signal of the first and the second set of quadrature signals does not vary by more than a factor four, preferably a factor two.

Clause 8: Differential optical interferometer according to clause 7, wherein the light generating means comprises a beam splitter provided downstream of the single frequency laser, wherein the beam splitter is configured to split the coherent source light beam into a first portion and a second portion, and to guide the first and second portion to the first and second optical terminal, respectively.

Clause 9: Differential optical interferometer according to clause 8, wherein the light generating means comprises a first light guide provided downstream of the beam splitter configured for guiding the first portion towards the first optical terminal. Preferably, the light generating means comprises a second light guide provided downstream of the beam splitter configured for guiding the second portion towards the second optical terminal. Preferably, an optical path length of the first light guide is larger than an optical path length of the second light guide.

Clause 10: Differential optical interferometer according to any one of clauses 7 to 9, wherein each of the first and second beam splitter comprises a non-polarizing beam splitter.

Clause 11: Differential optical interferometer according to any one of the clauses 7 to 10, wherein one of the detecting means and the processing means is configured to determine a first and second amplitude of the first and second interference signal, respectively.

Clause 12: Differential optical interferometer according to clause 11, wherein the first and second amplitude are determined by one of detecting zero crossings of the first and second interference signal and fitting a first and second function to the first and second interference signal, respectively.

Clause 13: Differential optical interferometer according to clause 11 or 12, further comprising an adapting means, wherein the delay corresponds to an optical path length difference and wherein the adapting means (134) is configured to modulate the optical path length difference with an amplitude corresponding to at least half of one of the first wavelength, the second wavelength and a nominal value of the first and second wavelength, preferably an amplitude of at least half of the larger one of the first and second wavelength.

Clause 14: Differential optical interferometer according to clause 13, wherein the optical path length difference is modulated by changing at least one of a length and a refractive index, preferably by exposure to at least one of heat, shear stress and a magnetic field.

Clause 15: Differential optical interferometer according to clause 13 or 14, wherein the light generating means comprises a first and second light guide configured for generating the delayed light beam and the light beam respectively, wherein the optical path length of the first light guide is longer than the second light guide, and wherein the light generating means further comprises the adapting means comprising one of a heating element, an actuator and an electromagnetic coil configured to modulate the optical path length of one of the first and second light guide.

According to a fifth aspect of the present disclosure the object is achieved by providing a differential optical interferometry system comprising a plurality of differential optical interferometers according to the second and fourth aspect. Each of the plurality of differential optical interferometers preferably share a common light generating means and are configured to detect a position of a target reflector in a measurement range directed along different non-parallel axes.

### BRIEF DESCRIPTION OF THE DRAWINGS

Aspects of the present disclosure will now be described in more detail with reference to the appended drawings, wherein same or like reference numerals illustrate same or like features, respectively.

FIG. 1A represents a schematic representation of a side view of an embodiment of a differential interferometer according to the second aspect of the present disclosure and configured for performing the method according to the first aspect of the present disclosure.

FIG. 1B represents a schematic representation of a top view of an embodiment of a differential interferometer according to the second aspect of the present disclosure and configured for performing the method according to the first aspect of the present disclosure.

FIG. 2 represents a schematic representation of an embodiment of a differential interferometer according to the fourth aspect of the present disclosure and configured for performing the method according to the third aspect of the present disclosure.

### DETAILED DESCRIPTION

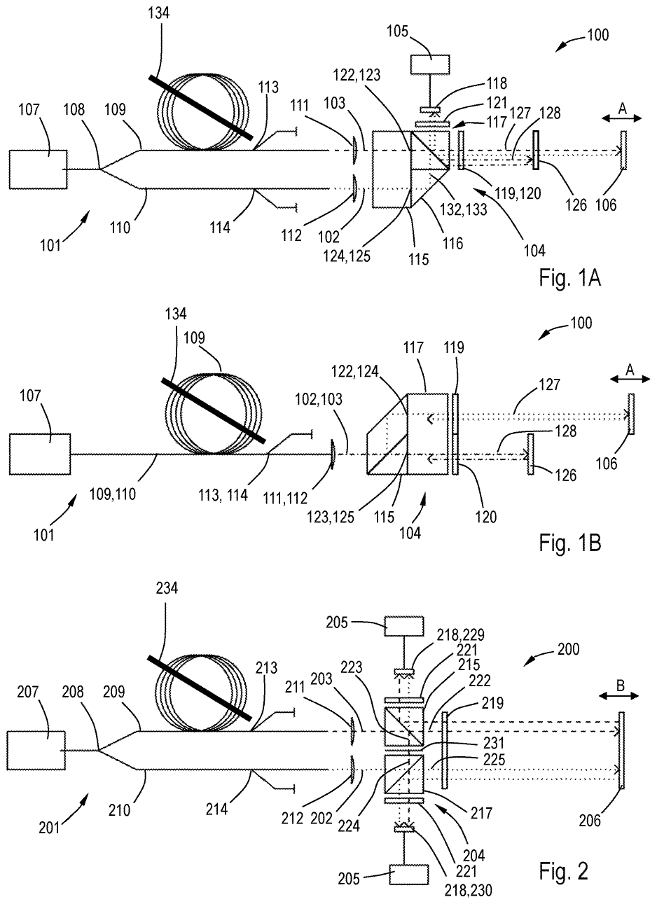

Referring to FIGS. 1A and 1B, an embodiment of a differential interferometer 100 according to the second aspect of the present disclosure suitable for performing a method according to the first aspect of the present disclosure, comprises a light generating means 101 configured for generating a light beam 102 and a delayed light beam 103, a sensor head 104 configured for generating a first interference signal and a second interference signal and a processing means 105 configured for determining a position of the target reflector 106 along measurement range A. Optionally, the differential interferometer 100 comprises an adapting means 134 configured to modulate an optical path length difference being introduced between generating the light beam 102 and generating the delayed light beam 103.

The light generating means 101 comprises a laser source 107, a beam splitter 108 (not shown in FIG. 1B), a first 109 and second 110 light guide and a first optical terminal 111 and second optical terminal 112. The laser source 107 provides light to a beam splitter 108 to split the light into a first and second portion. The beam splitter 108 is configured to guide the first portion to the first light guide 109 and the second portion to the second light 110. The first light guide 109 is configured to provide a delay path and the second light guide 110 is configured to provide a path. To provide a delay, the delay path is configured to have a longer optical path length than the path. The first light guide 109 comprises a first optical terminal 111 comprising the first collimator configured such that the generated delayed light beam 103 is collimated. The second light guide 110 comprises a second optical terminal 112 comprising the second collimator configured such that the generated light beam 102 is collimated.

The first 109 and second 110 light guide may each comprise one or more additional beam splitters 113, 114 configured to provide one or more additional light beams and one or more additional delayed beams to one or more additional sensor heads. Such additional sensor head may for instance be configured to determine a position of the target reflector 106 or another target reflector in a measurement range along another axis. For instance, the other axis is arranged orthogonal the axis.

The sensor head 104 comprises a first beam splitter 115, a reflector 116, a second beam splitter 117 and a detecting means 118. In the event that the second beam splitter 117 is configured as a polarizing beam splitter, the sensor head 100 may further comprise a first 119 and a second 120 quarter wave plate and a polarizing means 121, comprising one or two polarizers.

In the shown embodiment, the first beam splitter 115 is a non-polarizing lateral displacement beam splitter. This first beam splitter receives the parallelly aligned light beam 102 and delayed light beam 103 and splits both into a first part 122, 124 and a second part 123, 125. Therefore, there are four light signals exiting the first beam splitter, the first 124 and second 125 part of the light beam and the first 122 and second 123 part of the delayed light beam. The first part 122 and the second part 123 of the delayed light beam travel along a first path 127 and a second path 128, respectively. The first 124 and second 125 part of the light beam travel along the third path 132 and the fourth path 133.

In the shown embodiment, the first and second part of the delayed light beam enter the second beam splitter 117 and the second beam splitter 117 is a polarizing beam splitter. Therefore, light of the first and second part of the delayed light beam in a first polarization state is guided towards the first 119 and second 120 quarter wave plate, respectively, to be turned into circularly polarized light.

The circularly polarized light of the first part and the second part of the delayed light beam is guided towards a target reflector 106 and a reference reflector 126, respectively. In the shown embodiment the target reflector 106 and the reference reflector 126 are provided away from the sensor head 104. In an alternative embodiment the reference reflector 126 may be provided by the sensor head 104 itself and may be attached to the second beam splitter 117, for instance via the second quarter wave plate 120.

The target reflector 106 and reference reflector 126 reflect the circularly polarized light of the first and second part back to the first and second quarter wave plate, respectively. The circularly polarized light is turned into linearly polarized light in a second polarization state, which is orthogonal to the first polarization state, by the first and second quarter wave plate. This light enters the second beam splitter 117 and is reflected by the beam splitter coating towards the polarizing means 121 and forms the first and second light signal.

The first 124 and second 125 part of the light beam are guided to the second beam 117 splitter by the reflector 116. The second beam splitter 117 allows passage of light of the first 124 and second 125 part of the light beam having a first polarization state and guides this light towards the polarizing means 121 and forms the third and fourth light signal. The sensor head is configured such that light of the first part of the light beam in a first polarization state (i.e. the third light signal) and light of the first part of the delayed light beam in a second polarization state (i.e. the first light signal) overlappingly reach the polarizing means 121. The sensor head is further configured such that light of the second part of the light beam in a first polarization state (i.e. the fourth light signal) and light of the second part the delayed light beam in the second polarization state (i.e. the second light signal) overlappingly reach the polarizing means 121.

The polarizing means 121 is configured to generate a first interference signal (e.g. by a first polarizer of the polarizing means) based on the first and third light signal. The polarizing means 121 is further configured to generate a second interference signal (e.g. by a second polarizer of the polarizing means) based on the second and fourth light signal.

The detecting means 118 is configured to detect the first and second interference pattern. For instance, the detecting means comprises a first and a second detector (e.g. photodiode) to detect the first and second interference pattern, respectively.

The processing means 105 is connected to the detecting means 118 and configured to determine a position of the target reflector 106 based on the first and second interference signal.

In the shown embodiment the delayed light beam 103 is used to generate the first and second light signal and the light beam 102 is used to generate the third and fourth light signal. It is however also possible to switch the light beam 102 and delayed light beam 103.

In another embodiment, the sensor head comprises a first beam splitter, a reflector and a second beam splitter. The second beam splitter is a non-polarizing beam splitter. Therefore, there is no need to provide any of a first and a second quarter wave plate, and a polarizing means, comprising one or two polarizers. The benefit is that it is cheaper, because less optical components are required and the alignment requirements of the optical components are less stringent.

Referring to FIG. 2, an embodiment of a differential interferometer 200 according to the fourth aspect of the present disclosure suitable for performing a method according to the third aspect of the present disclosure, comprises a light generating means 201 configured for generating a light beam 202 and a delayed light beam 203, a sensor head 204 configured for generating a first interference signal and a second interference signal and a processing means 205 configured for determining a position of the target reflector 206 along measurement range B. Optionally, the differential interferometer 200 comprises an adapting means 234 configured to modulate an optical path length difference being introduced between generating the light beam 202 and generating the delayed light beam 203.

The light generating means 201 comprises a laser source 207, a beam splitter 208, a first 209 and second 210 light guide and a first optical terminal 211 and a second optical terminal 212. The laser source 207 provides light to the beam splitter 208 to split the light into a first and second portion. The beam splitter 208 is configured to guide the first portion to the first light guide 209 and the second portion to the second light 210. The first light guide 209 is configured to provide a delay path and the second light guide 210 is configured to provide a path. To provide a delay, the delay path is configured to have a longer optical path length than the path. The first light guide 209 comprises a first optical terminal 211 comprising the first collimator configured such that the generated delayed light beam 203 is collimated. The second light guide 210 comprises a second optical terminal 212 comprising the second collimator configured such that the generated light beam 202 is collimated.

The sensor head comprises a first beam splitter 215, a second beam splitter 217 and a detecting means 218, comprising a first 229 and a second 230 detector. The first 215 and second 217 beam splitter are both non-polarizing beam splitter. The first 215 and second 217 beam splitter receive the parallelly aligned delayed light beam 203 and light beam 202.

The first beam splitter 215 splits the delayed light beam 203 into a first 222 and second 223 part. The first part 222 of the delayed light beam traverses the first beam 215 splitter and is guided towards the target reflector 206. The target reflector 206 reflects the first part of the delayed light beam back towards the first beam splitter 215 and the beam splitter coating of the first beam splitter 215 guides (e.g. reflects) the first part of the delayed light beam towards the first detector 229 as the first light signal.

The second part 223 of the delayed light beam 203 is directed towards the second beam splitter 217. The second part of the delayed light beam traverses the second beam splitter 217 and is guided towards the second detector 230 as the second light signal.

The second beam splitter splits the light beam into a first 224 and second 225 part. The first part 224 of the light beam is directed towards the first beam splitter 215. The first part 224 of the delayed light beam traverses the first beam splitter 215 and is guided towards the first detector 229 as the fourth light signal.

The second part 225 of the light beam traverses the second beam splitter 217 and is guided towards the target reflector 206. The target reflector 206 reflects the second part of the light beam back towards the second beam splitter 217 and the beam splitter coating of the second beam splitter 217 guides (e.g. reflects) the second part of the light beam towards the second detector 230 as the third light signal.

The first interference signal is formed by the first and the third light signal and the second interference signal is formed by the second and the fourth light signal. The first 229 and second 230 detector detect the first and the second interference signal, respectively. A processing means 205 connected to the first 229 and second 230 detector determines the position of the target reflector 206 based on the first and second interference signal.

For noise reduction, the first 215 and second 217 beam splitter may both be configured as polarizing beam splitters. In such embodiment, the interferometer 200 further comprises a quarter wave plate 219 provided between the first beam splitter 215 and the target reflector 206 and between the second beam splitter 217 and the target reflector 206. Furthermore, a half wave plate 231 is provided between the first 215 and second 217 beam splitter, and a polarizing means 221 comprising a first polarizer provided upstream of the first detector and a second polarizer upstream of the second detector.

1. A method for determining a position of a target reflector in a measurement range by differential optical interferometry, the method comprising:
generating a coherent source light beam using a single frequency laser, wherein the coherent source light beam is modulated between a first and a second wavelength,
generating a light beam and a delayed light beam from the coherent source light beam, wherein the delayed light beam comprises a delay with respect to the light beam, and wherein the light beam is arranged in parallel to the delayed light beam
splitting each of the light beam and the delayed light beam into a first and second part, wherein the second part is arranged in parallel to the corresponding first part,
generating a first light signal by guiding the first part of one of the light beam and delayed light beam along a first path comprising the target reflector,
generating a second light signal by guiding the second part of the one of the light beam and delayed light beam along a second path comprising a reference reflector, wherein the second path is arranged in parallel to the first path,
generating a third light signal by guiding the first part of the other one of the light beam and delayed light beam along a third path,
generating a fourth light signal by guiding the second part of the other one of the light beam and delayed light beam along a fourth path, wherein the fourth path is arranged in parallel to the third path,
generating a first interference signal between the first light signal and the third light signal,
generating a second interference signal between the second light signal and the fourth light signal, and
determining the position of the target reflector based on the first and the second interference signal.

2. The method according to claim 1, wherein determining the position comprises determining a quadrature by demodulating each of the first and second interference signal, and wherein the delay corresponds to an optical path length difference configured such that an amplitude of each demodulated first and second interference signal does not exhibit a zero crossing over the measurement range.

3. The method according to claim 1, wherein generating the light beam and the delayed light beam from the coherent source light beam comprises splitting the coherent source light beam into a first portion and a second portion, and guiding the first portion along a delay path and guiding the second portion along a path, wherein the delay is generated by an optical path length of the delay path being larger than an optical path length of the path.

4. The method according to claim 1, wherein generating the first and the second interference signal comprises using a polarizing means.

5. The method according to claim 1, wherein splitting each of the light beam and the delayed light beam into the first and second part comprises introducing a second delay between the first and corresponding second part for both the light beam and the delayed light beam, wherein the second delay introduced between the first and second part by splitting the light beam corresponds to the second delay introduced between the first and second part by splitting the delayed light beam.

6. The method according to claim 1, further comprising determining a first amplitude of the first interference signal and a second amplitude of the second interference signal, and wherein determining the position of the target reflector is further based on the first and second amplitude.

7. The method according to claim 6, wherein the first and second amplitude are determined by one of detecting zero crossings of the first and second interference signal and fitting a first and second function to the first and second interference signal, respectively.

8. The method according to claim 6, wherein the delay corresponds to an optical path length difference and wherein the optical path length difference is modulated with an amplitude corresponding to at least half of one of the first wavelength, the second wavelength and a nominal value of the first and second wavelength.

9. The method according to claim 8, wherein the optical path length difference is modulated by changing at least one of a length and a refractive index.

10. A differential optical interferometer for determining a position of a target reflector in a measurement range, the differential optical interferometer comprising:
a light generating means comprising a single frequency laser and being configured to generate a coherent source light beam being modulated between a first and a second wavelength;
the light generating means further comprising a first and a second optical terminal, wherein the light generating means is configured to manipulate the coherent source light beam to generate a delayed light beam at the first optical terminal and a light beam at the second optical terminal, wherein the delayed light beam is delayed with respect to the light beam;
a sensor head disposed downstream of the first and second optical terminal, wherein the delayed light beam is arranged in parallel to the light beam; wherein
the sensor head comprises a first beam splitter and a second beam splitter disposed downstream of the first beam splitter, wherein
the first beam splitter is configured to split each of the light beam and the delayed light beam into a first and second part, wherein
the second beam splitter is configured to generate a first light signal by guiding the first part of one of the light beam and delayed light beam along a first path comprising a target reflector, configured to generate a second light signal by guiding the second part of the one of the light beam and delayed light beam along a second path comprising a reference reflector, wherein the second path is arranged in parallel to the first path, configured to generate a third light signal by allowing passage of at least part of the first part of the other one of the light beam and delayed light beam along a third path, and configured to generate a fourth light signal by allowing passage of at least part of the second part of the other one of the light beam and delayed light beam along a fourth path, wherein the fourth path is arranged in parallel to the third path; wherein
the sensor head is configured to generate a first interference signal between the first light signal and the third light signal, and to generate a second interference signal between the second light signal and the fourth light signal; and wherein
the sensor head comprises a detecting means configured to detect the first and the second interference signal, and
a processing means configured to determine a position of the target reflector based on the first and second interference signal.

11. The differential optical interferometer according to claim 10, wherein the processing means is configured to determine the position by determining a first and a second set of quadrature signals by demodulating the first and second interference signal, respectively, and wherein the delayed light beam is delayed with respect to the light beam by introducing an optical path length difference configured such that an amplitude of each quadrature signal of the first and the second set of quadrature signals does not exhibit a zero crossing over the measurement range.

12. The differential optical interferometer according to claim 10, wherein the light generating means comprises a beam splitter disposed downstream of the single frequency laser, wherein the beam splitter is configured to split the coherent source light beam into a first portion and a second portion suitable for being guided to the first and second optical terminal, respectively.

13. The differential optical interferometer according to claim 12, wherein the light generating means comprises a first light guide disposed downstream of the beam splitter and configured to guide the first portion towards the first optical terminal.

14. The differential optical interferometer according to claim 13, wherein the first light guide comprises a first polarizing maintaining fiber.

15. The differential optical interferometer according to claim 10, wherein one or more of the following applies:
the first beam splitter comprises a lateral displacement beam splitter;
the second beam splitter comprises a second polarizing beam splitter; and/or
the sensor head comprises a polarizing means configured to generate the first and the second interference signal.

16-17. (canceled)

18. The differential optical interferometer according to claim 10, wherein one of the detecting means and the processing means is configured to determine a first and second amplitude of the first and second interference signal, respectively.

19. The differential optical interferometer according to claim 18, wherein the first and second amplitude are determined by one of detecting zero crossings of the first and second interference signal and fitting a first and second function to the first and second interference signal, respectively.

20. The differential optical interferometer according to claim 18, further comprising an adapting means, wherein the delay corresponds to an optical path length difference and wherein the adapting means is configured to modulate the optical path length difference with an amplitude corresponding to at least half of one of the first wavelength, the second wavelength, and a nominal value of the first and second wavelength.

21. The differential optical interferometer according to claim 20, wherein the optical path length difference is modulated by changing at least one of a length and a refractive index, preferably by exposure to at least one of heat, shear stress and a magnetic field.

22. The differential optical interferometer according to claim 20, wherein the light generating means comprises a first and second light guide configured to generate the delayed light beam and the light beam respectively, wherein an optical path length of the first light guide is longer than an optical path length of the second light guide, and wherein the light generating means further comprises the adapting means comprising one of a heating element, an actuator and an electromagnetic coil configured to modulate the optical path length of one of the first and second light guide.
